(19) United States
(12) Patent Application Publication
(10) Pub. No.: US 2005/0201558 A1
(43) Pub. Date: Sep. 15, 2005

(54) Encryption apparatus and image forming apparatus

(75) Inventors: Toshiyuki Watanabe, Yokohama-shi (JP); Keiichi Hinaga, Susono-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/076,342

(22) Filed: Mar. 9, 2005

(30) Foreign Application Priority Data
Mar. 10, 2004 (JP) 2004-068152

(51) Int. Cl. H04N 7/167; G06F 11/30; G06F 12/14; H04L 9/00; H04L 9/32

(52) U.S. Cl. 380/211; 713/200

(57) ABSTRACT

An encryption apparatus and an image forming apparatus are provided, in which measures are taken to prevent the encryption-key code from leaking outside. An encryption-key code is stored in a volatile memory that is soldered to a board. A lithium button-cell is used as backup power supply for the volatile memory. A wire that is provided on the board connects the lithium button-cell to the volatile memory.

### CROSS-REFERENCE TO RELATED APPLICATIONS

This application is based upon and claims the benefit of priority from prior Japanese Patent Application No. 2004-068152, filed Mar. 10, 2004, the entire contents of which are incorporated herein by reference.

### BACKGROUND OF THE INVENTION

1. Field of the Invention

The present invention relates to an encryption apparatus and an image forming apparatus. More particularly, the invention relates to an encryption apparatus and an image forming apparatus, in which measures are taken against theft of the encryption-key code used in encrypting data.

2. Description of the Related Art

In an image forming apparatus, the image data read from a document may be stored in a recording medium such as a hard disk. The image data recorded in the hard disk is read so that the image represented by the data may be formed on the image-transfer drum. The image is transferred from the drum to a paper sheet. The image data is encrypted before it is recorded on the hard disk and decrypted after it is read from the hard disk. Hence, the classified data, the personal data and the like, which are stored in the hard disk, are safe from unauthorized use even if the hard disk is removed and stolen.

When the image forming apparatus is installed anew, an encrypting function is incorporated into the apparatus so that data may be encrypted before it is stored in the hard disk. Then, the service engineer activates the encryption-key code input function of the apparatus, only once. After the encryption-key code input function has been activated, the manager in charge of the image forming apparatus operates the operation panel of the apparatus, inputting the encryption-key code two times. If the code input is correct, it is stored as encryption-key code in the nonvolatile memory (NVRAM) that is mounted on the system board of the image forming apparatus. Thereafter, the key code stored in the NVRAM is read only once when the power switch on the image forming apparatus is turned on. The key code thus read is temporarily stored in the volatile memory mounted on the scrambler board of the image forming apparatus. The key code is used to encrypt and decrypt data. When the power switch of the apparatus is turned off, the key code is erased from the volatile memory mounted on the scrambler board. A technique of writing a key code in a nonvolatile memory is known, as is disclosed in Japanese Unexamined Patent Publications No. 9-282156.

The encryption-key code is not sufficiently safe against theft. This is because it is stored in the nonvolatile memory (NVRAM), which is mounted on the system board. Various data items for operating the image forming apparatus are stored in the NVRAM, too. The NVRAM can be removed from the system board. Therefore, not only these data items, but also the encryption-key code may be stolen.

### BRIEF SUMMARY OF THE INVENTION

An aspect of this invention is to provide an encryption apparatus and an image forming apparatus, in which measures are taken to prevent the encryption-key code from leaking outside.

According to the aspect of the invention, there is provided an encryption apparatus comprising a board, an encryption chip, a volatile memory, a backup battery, and a wire. The encryption chip is mounted on the board. It encrypts data to be recorded in a hard disk and decrypts data read from the hard disk. The volatile memory is soldered to the board and stores an encryption-key code. The encryption-key code may be transferred to, and used in, the encryption chip. The backup battery is secured to the board and supplies power to the volatile memory. The wire connects the backup battery to the volatile memory.

When the volatile memory is removed from the board, it is electrically disconnected from the backup battery. Thus, the encryption-key code is no longer stored in the volatile memory once the memory is removed from the board.

Additional aspects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the hardware configuration of an embodiment of the present invention;

FIG. 2 is a block diagram illustrating how the software acts on the hardware in the embodiment of the invention; and

FIG. 3 is a flowchart showing various steps that a service engineer and a manager perform when the embodiment, i.e., an image forming apparatus, is installed anew.

### DETAILED DESCRIPTION OF THE INVENTION

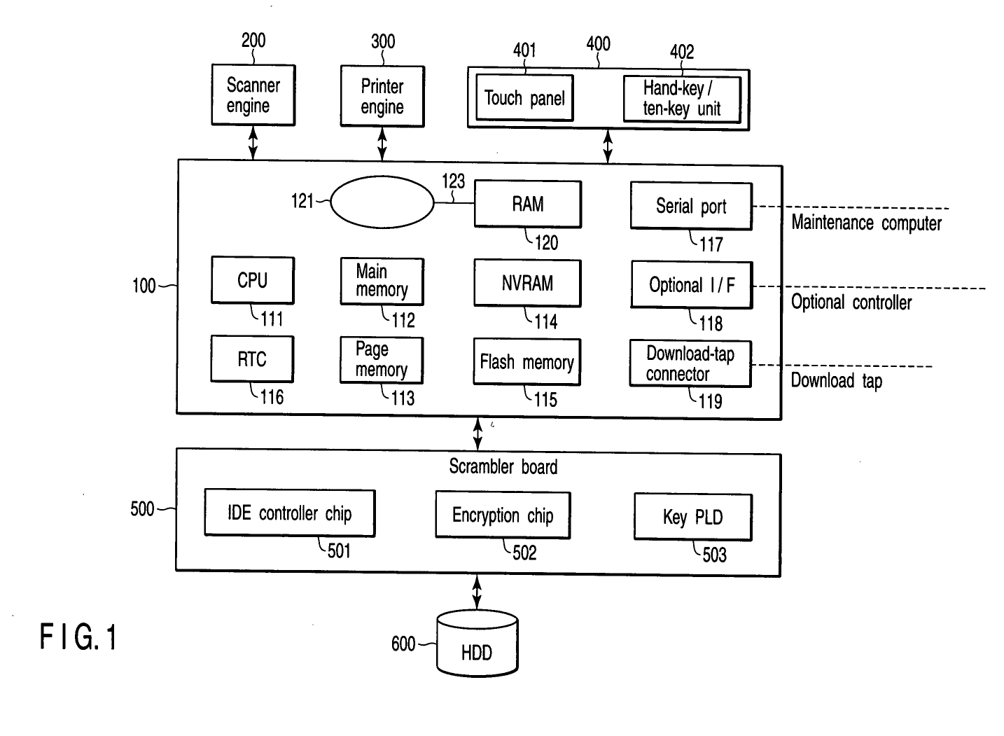

An embodiment of the invention will be described, with reference to the accompanying drawings. The embodiment is an image forming apparatus. As FIG. 1 shows, the image forming apparatus incorporates a system board 100. The system board 100 has an input/output interface (not shown). A scanner engine 200, a printer engine 300, an operation panel 400, and a scrambler board 500 are connected to the input/output interface, each by an input/output interface (not shown). An input/output interface connects a hard disk drive 600 to the scrambler board 500.

The operation panel 400 includes a touch panel 401 and a hand-key/ten-key unit 402. The panel 400 has a liquid crystal display. The user operates the keys provided on the operation panel 400, so that at least copying can be carried out. The scrambler board 500 includes an IDE controller chip 501, an encryption chip 502, and a key-programmable logic device (PLD) 503. The IDE controller chip 501 is a logic element (chip) that controls the data transfer to the HDD 600. The chip 501 holds ID data showing that the scrambler board 500 has been mounted on the system board 100. The encryption chip 502 transfers first encrypts data and then transfers the data to the HDD 600. The chip 502 decrypts data read from the HDD 600. The PLD 503 is a logic element that holds an encryption-key code, which was transferred to the scrambler board 500 from a volatile memory 120 (provided on the system board) when the image forming apparatus is activated.

Various components are provided on the system board 100. A central processing unit (CPU) 111 is mounted on the center part of the system board 100. The CPU 111 controls some other components of the image forming apparatus. A main memory 112 is mounted on the system board 100, too. It is used as a memory for storing the system program and the like loaded from a flash ROM 115 when the image forming apparatus is activated. A page memory 113 is used to store data temporarily when a document is read or when data is printed. An NVRAM 114 is a nonvolatile memory that stores various setting data items. One of these data items shows whether the scrambler board 500 has been mounted on the board 100. Some others of these data items are various parameters.

The volatile memory 120 receives power from a backup battery 121 (e.g., lithium button-cell). The memory 120 is a volatile memory that stores various setting data items, which include the encryption-key code. A patterned wire 123 connects the volatile memory 120 to the backup battery 121. The memory 120 and the battery 121 may be arranged in one surface of the system board 100 or on the upper and lower surfaces thereof, respectively.

The volatile memory 120 is soldered to the system board 100. When the memory 120 is removed from the board 100, it no longer receives power from the backup battery 121. As a result, the encryption-key code is erased from the volatile memory 120.

The flash ROM 115 is provided on the system board 100, along with a real-time clock (RTC) 116, a serial port 117, an optional I/F 118 and a download-tap connector 119. The flash ROM 115 is a nonvolatile memory that stores the software for controlling the main unit and the scrambler board 500. The RTC 116 is an IC that generates data representing the real time.

The serial port 117 is an interface that service engineers may use to acquire the maintenance information. The optional I/F 118 is an interface provided for an optional controller and can be used when the image forming apparatus is connected to a network. The download-tap connector 119 is a connector that service engineers may use to download programs and UI data. A service engineer may attach an EPROM storing the system-board software and UI data to the download-tap board. In this case, the software that is required in the scrambler board 500 is downloaded into the flash ROM 115 mounted on the system board 100, and the UI data is downloaded into the HDD 600.

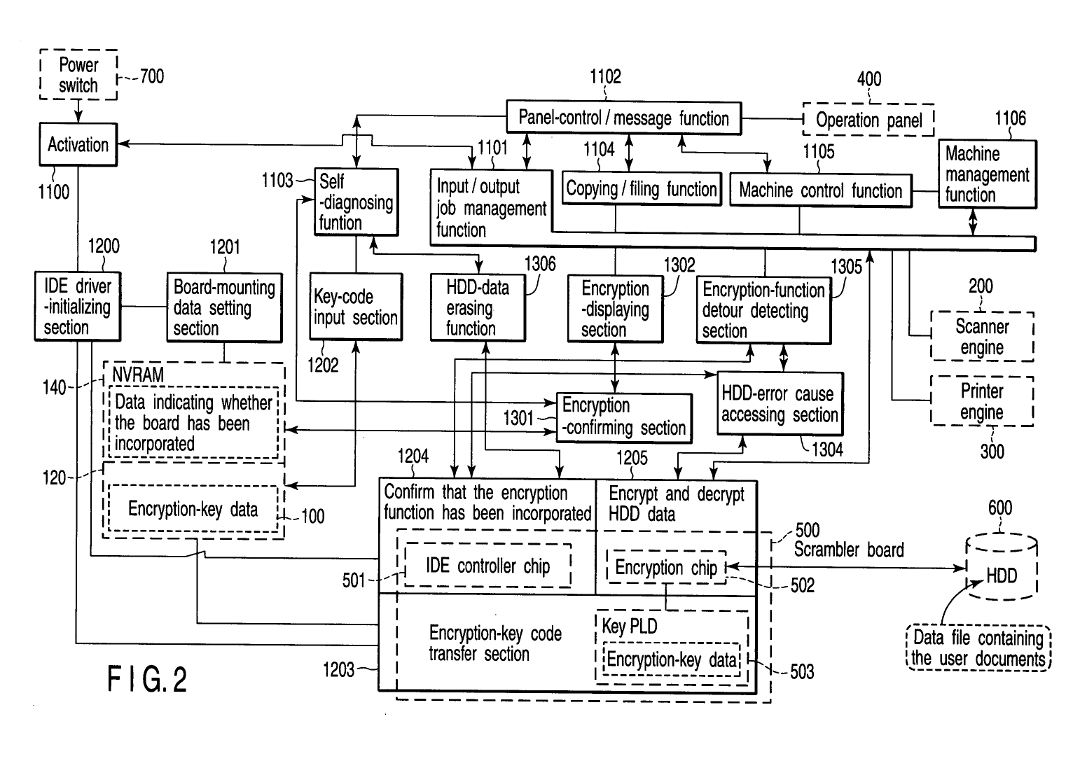

FIG. 2 shows the hardware components incorporated in the image forming apparatus and the function blocks that are constructed when the software is installed into the image forming apparatus. The function blocks are indicated as solid-line boxes, while the hardware components are represented as broken-line boxes.

The function blocks will be described, one by one. When the power switch 700 is turned on, the image forming apparatus is activated. In the apparatus, an input/output job management function 1101 controls various jobs while the apparatus is performing copying and scanning a document. Among the jobs are: the job of reading the document (performed by the scanner engine 200), the job of printing data (performed by the printer engine 300), the job of storing data in the HDD 600, and the job of reading data from the HDD 600. A panel-control/message function 1102 works to display buttons and messages as the user operates the operation panel 400, and to display the condition in which a copying/filing function 1104 is controlled and the condition in which a machine control function 1105 operates.

The machine control function 1105 controls the input/output job management function 1101, which in turn controls the scanner engine 200, the printer engine 300 and the like. The function 1105 is controlled by machine management function 1106. The function 1105 can cause the input/output job management function 1101 to control self-diagnosing function 1103. The function 1105 so operates when a service engineer operates the operation panel 400. When the service engineer inspects and maintains the image forming apparatus, the panel-control/message function 1102 causes the liquid crystal display to display section the results of the inspection and the maintenance items performed. The self-diagnosing function 1103 can acquire data from an encryption-confirming section 1301. It can acquire data from HDD-data erasing function 1306. The encryption-function confirming section 1301 determines whether the image forming apparatus incorporates the system board 100. More precisely, it can be requested that the data stored in the NVRAM 114 be read. An encryption-display section 1302 detects the operation of the encryption-function confirming section 1301, and displays that the confirming of the operation.

An IDE driver-initializing section 1200 causes a board-mounting data setting section 1201 to set data that shows whether the system board 100 has been incorporated in the image forming apparatus. The IDE driver-initializing section 1200 initializes an encryption-function-mounting confirming section 1204, an encryption-key code transfer section 1203, and an HDD-data encrypting/decrypting section 1205.

The user may operate the operation panel 400, generating a key code. The key code is supplied to a key-code input section 1202. The key-code input section 1202 can write the key code, as encryption-key code, to the volatile memory 120.

An encryption-function detour detecting section 1305 acquires data which has been set by the encryption-function-mounting confirming section 1204 and which indicates the cause of an HDD error. When the HDD 600 makes an error, the section 1305 causes the operation panel to display the data. Reading the data displayed on the panel, the user may call a service engineer. An HDD-error cause accessing section 1304 recognizes the cause of the error the HDD 600 has made.

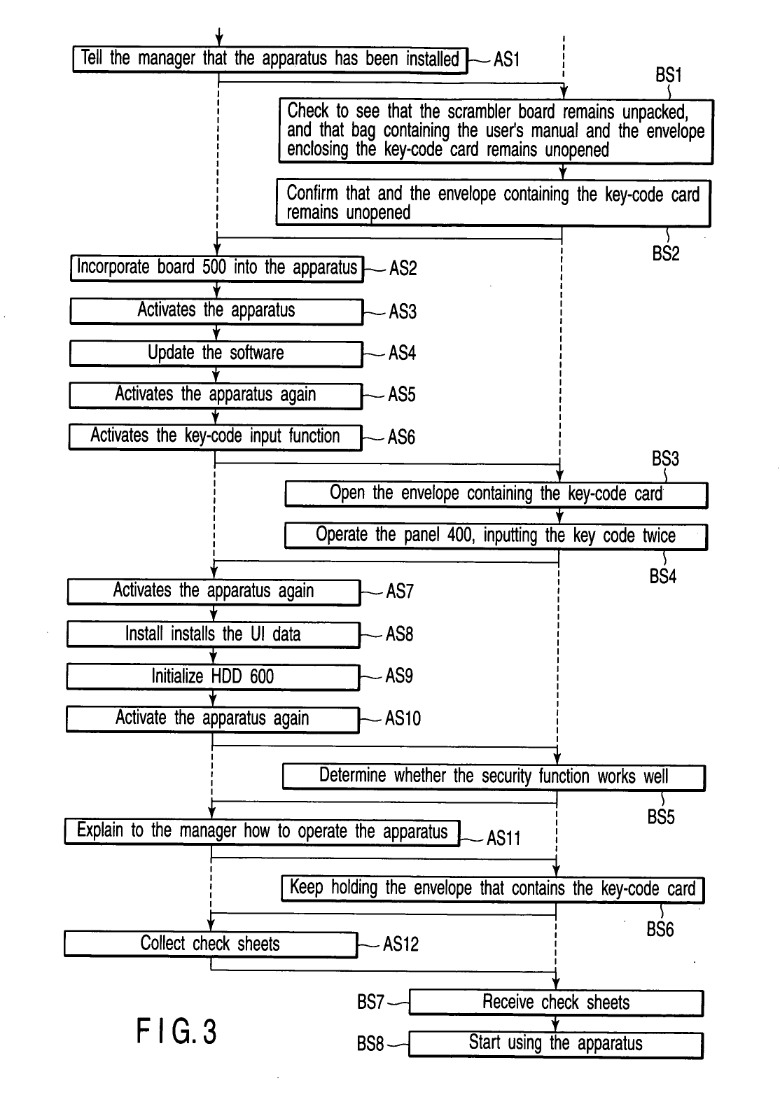

FIG. 3 is a flowchart showing the sequence of setting the function of the scrambler board 500. The steps shown in the left half of FIG. 3 are performed by the service engineer. The steps shown in the right half of FIG. 3 are performed by the manager in charge of the image forming apparatus.

Upon installing the image forming apparatus, the service engineer tells the manager that the apparatus has been duly installed (Step AS1). The manager checks to see that the scrambler board 500 remains unpacked and that the bag containing the user's manual and the envelope enclosing the key-code card remains unopened (Step BS1). Further, the manager confirms that and the envelope containing the key-code card remains unopened (Step BS2). Then, the service engineer takes the scrambler board 500 from the package and incorporates the board 500 into the image forming apparatus (Step AS2).

Next, the service engineer activates the image forming apparatus (Step AS3). The service engineer updates the software (Step AS4) and activates the image forming apparatus again (Step AS5). The service engineer then activates the key-code input function (Step AS6). Next, the manager opens the envelope containing the key-code card (Step BS3). The manager operates the panel 400, inputting the key code twice (Step BS4). Then, the service engineer activates the image forming apparatus again (Step AS7) and installs the UI data (Step AS8). Then, the HDD 600 is initialized (Step AS9), and the image forming apparatus is activated again (Step AS10).

Next, the manager determines whether the security function works well (Step BS5). The service engineer explains how to operate the image forming apparatus (Step AS11). The manager receives the envelope that contains the key-code card (Step BS6). The service engineer collects check sheets (Step AS12) and gives a copy of the check sheets to the manager (Step BS7). The image forming apparatus is set in conditions for general use (Step BS8).

In the present invention, the backup battery 121 and the volatile memory 120 may be provided on the same surface of the system board 100. Alternatively, they may be provided on two opposite surfaces of the board 100, respectively. In this case, they may be electrically connected by a conductor formed in a through hole made in the system board 100. The invention can be applied not only to image forming apparatuses, but also to methods of storing encryption-key codes in various types of apparatuses.

The present invention is not limited to the embodiment described above. The components of the embodiment can be modified in various manners in reducing the invention to practice, without departing from the sprit or scope of the invention. Further, the components of any embodiment described above may be combined, if necessary, in various ways to make different inventions. For example, some of the component of the embodiment may not be used. Moreover, the components of the different embodiments may be combined in any desired fashion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An encryption apparatus comprising:
a board;
an encryption chip which is mounted on the board and which encrypts data to be recorded in a hard disk and decrypts data read from the hard disk;
a volatile memory which is soldered to the board and which stores an encryption-key code to be transferred to, and used in, the encryption chip;
a backup battery which is secured to the board and which supplies power to the volatile memory; and
a wire which connects the backup battery to the volatile memory.

2. The encryption apparatus according to claim 1, wherein the board comprises a scrambler board on which the encryption chip is mounted, and a system board on which the volatile memory and the backup battery are mounted.

3. The encryption apparatus according to claim 1, wherein the backup battery and the volatile memory are arranged on one surface of the board.

4. The encryption apparatus according to claim 1, wherein the backup battery and the volatile memory are arranged on two opposite surfaces of the board, respectively.

5. An image forming apparatus comprising:
a system board;
an extension memory which is mounted on the system board and configured to store an encryption-key code;
a backup battery which is mounted on the system board and which supplies power to the extension memory;
a wire which connects the backup battery to the extension memory;
a hard disk drive for storing image data read from a document;
a scrambler board;
a key-programmable logic device which is mounted on the scrambler board and which temporarily stores the encryption-key code transferred from the extension memory; and
an encryption chip which is mounted on the scrambler board and which uses the encryption-key code stored in the key-programmable device to encrypt data to be written in a hard disk provided in the hard disk drive and to decrypt data read from the hard disk.

6. The image forming apparatus according to claim 5, wherein the scrambler board is incorporated when the apparatus is installed.

7. The image forming apparatus according to claim 6, further comprising a function of updating software.

8. The image forming apparatus according to claim 7, further comprising a function of receiving the encryption-key code from an external apparatus.

9. The image forming apparatus according to claim 8, further comprising an operation panel which is operated to input the encryption-key code.

10. The image forming apparatus according to claim 5, further comprising a function of initializing the hard disk.

11. An image forming apparatus comprising:
a first means being mounted on a system board, for storing an encryption-key code;
a second means being mounted on a system board, for supplying power to the first means;
a third means for connecting the first and second means;
a forth means including a hard disk drive, for storing image data read from a document;
a fifth means being mounted on a scrambler board, for temporarily storing the encryption-key code transferred from the first means; and
a sixth means being mounted on a scrambler board, for using the encryption-key code stored in the fifth means to encrypt data to be written in a hard disk provided in the forth means and to decrypt data read from the hard disk.

12. The image forming apparatus according to claim 11, wherein the scrambler board is incorporated when the apparatus is installed.

13. The image forming apparatus according to claim 12, further comprising a function of updating software.

14. The image forming apparatus according to claim 13, further comprising a function of receiving the encryption-key code from an external apparatus.

15. The image forming apparatus according to claim 14, further comprising an operation panel which is operated to input the encryption-key code.

16. The image forming apparatus according to claim 11, further comprising a function of initializing the hard disk.
